(19) United States
(12) Patent Application Publication
(10) Pub. No.: US 2005/0256945 A1
(43) Pub. Date: Nov. 17, 2005

(54) Method and system for optimization of controls

(76) Inventors: Michael A. Martin, Round Rock, TX (US); Jaisimha Muthegere, Austin, TX (US); Timothy L. Smith, Austin, TX (US); Robert F. Tulloh, Austin, TX (US)

Correspondence Address: TOLER & LARSON & ABEL L.L.P., 5000 PLAZA ON THE LAKE STE 265, AUSTIN, TX, 78746, US

(21) Appl. No.: 10/746,806

(22) Filed: Dec. 24, 2003

(51) Int. Cl. G06F 15/173

(52) U.S. Cl. 709/223

(57) ABSTRACT

A system and method can use statistical modeling of the way that an entire application environment is running. The output from the statistical models can be used by an optimization engine to provide an optimal or near optimal configuration and operation of the application environment for nearly any workloads and conditions. After constructing the statistical models, the operation can be entirely automated and not require human intervention. In another embodiment, some human intervention may be used or desired, particularly for non-reoccurring events (e.g., significant portion of a network for the application environment shut down due to a natural disaster). The system and method can be used to respond faster (closer to real time) and potentially to implement better control than would otherwise be possible with manual control. The system and method is particularly well suited for application environments that are in a nearly constant state of flux.

### FIELD OF THE INVENTION

The invention relates in general to methods and systems for managing a network, and more particularly to methods and systems for managing an application environment on a network.

### DESCRIPTION OF THE RELATED ART

More companies are using web-enabled applications over a network, such as an intranet (internal network) or the Internet (external network). These companies need to ensure that transactions are correctly processed or the companies may miss revenue, profit, or other opportunities. Attempts to improve the likelihood that a transaction will be completed typically have focused on hardware solutions (e.g., load balancing, reconfiguration etc.), assigning priority based on identification of a user, department, etc., and potentially other static factors. These attempts address parts of a network independently or nearly independently of the other parts of the network. Those attempts do not address the true issue, which is to provide a consistent and dependable level of application quality of service over a network.

Networks can include many different types of components, and within each type of components, different environments may be running. New equipment or software may be added, removed, or replace existing equipment or software. Also, the behavior of the network is typically complex.

Software monitoring products, such as BMC PATROL™ software, perform distributed monitoring for parts of the network. Those products have a stimulus-response type of approach. In other words, if a specified condition or situation occurs, a set of actions may be automatically performed. For example, a warning may be sent to the user. However, fixing the problem becomes a very manual process, as the user then has to determine what actions to take.

A list of choices of what actions the user can take to try to correct the problem may be displayed. At this point, the user may decide to terminate a process or reboot a machine. These types of choices are very IT-specific kinds of choices. The IT professional is left with the decision of which control to select and how much to change it, and therefore, the experience level of the IT professional and his or her experience with the current environments are important factors. further, a database administrator and a network administrator may see the same problem at the same time and address it with different solutions. However, the solutions, when both are deployed, may not be compatible with each other and cause a problem worse than the original problem. Also, the IT professional may be seeing a new environment that he or she has not seen before due to new equipment or a new software product, and therefore, the IT professional needs to “re-learn” how the system responds when different controls and values of the controls are used.

Along similar lines, event management products, such as like Tivoli Enterprise Console™ software, can perform rule interpretation. A user defines what are the kinds of events the system will monitor and then what actions to perform in response to those events. The ability to correctly resolve the problem has similar limitations as previously described with monitoring software products. The user must have seen or is anticipating a problem. Also, the rules may not deal with exceptional conditions.

Attempts to remove human intervention provide incomplete solutions. A “self-healing” server has been proposed. The server can automatically be monitored and adjusted to improve its operation. However, this does not address other components of the network, such as databases, external memories (e.g., hard disks), or software running on the server.

The behavior of the network is getting to the point where correct solutions may be counter-intuitive to humans. Therefore, a true solution cannot rely on human intervention or predetermined rules defined by humans. Further, all or nearly all of the components within the network should be considered when formulated a solution.

The previously described attemps are more directed to correcting problem conditions, and are not directed to optimizing an application environment. An application environment can be optimized even though it may not be detected as having a problem condition.

### SUMMARY

A system and method can use statistical modeling of the way that an entire application environment is running. The output from the statistical models can be used by an optimization engine to provide an optimal or near optimal configuration and operation of the application environment for nearly any workloads and conditions. After constructing the statistical models, the operation can be entirely automated and not require human intervention. In another embodiment, some human intervention may be used or desired, particularly for non-reoccurring events (e.g., significant portion of a network for the application environment shut down due to a natural disaster). The system and method can be used to respond faster (closer to real time) and potentially to implement better control than would otherwise be possible with manual control. The system and method is particularly well suited for application environments that are in a nearly constant state of flux.

In one set of embodiments, a method of managing an application environment on a network can include using predictive modeling based at least in part on state information originating from the network to generate an output. The method can also include determining a value using an optimization function based at least in part on the output from the predictive modeling and determining if a criterion is met based at least in part on the value.

In still another set of embodiments, a method of managing an application environment on a network can include determining whether state information matches an entry within an ontology. The state information may include a current control setting for a control. The method can also include changing the control from the current control setting to an original control setting after determining whether the state information matches the entry within the ontology.

In further sets of embodiments, data processing system readable media can comprise code that includes instructions for carrying out the methods and may be used on the systems.

In still a further set of embodiment, a system for managing an application environment on the network can include an optimization engine that is configured to use state information originating from the network. In one embodiment, the system may include a rules decision engine, an ontology engine, or both. In another embodiment, the system may include a first neural network for making an estate prediction, a second neural network for making an appstate prediction, or both.

The foregoing general description and the following detailed description are exemplary and explanatory only and are not restrictive of the invention, as defined in the appended claims.

### BRIEF DESCRIPTION OF THE DRAWINGS

The present invention is illustrated by way of example and not limitation in the accompanying figures.

FIG. 1 includes an illustration of a hardware configuration of a system for managing an application that runs on a network.

FIG. 2 includes an illustration of a hardware configuration of the application management appliance in FIG. 1.

FIG. 3 includes an illustration of hardware configuration of one of the management blades in FIG. 2.

FIG. 4 includes an illustration of a configuration using to optimize the environment for an application running on a network in accordance with an embodiment of the present invention.

FIG. 5 includes a process flow diagram for using the configuration in FIG. 4 to optimize the environment for an application running on a network in accordance with an embodiment of the present invention.

FIG. 6 includes a process flow diagram for one portion of the process illustrated in FIG. 5.

FIG. 7 includes an illustration of a configuration used during a learning session for a neural network in accordance with an embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Reference is now made in detail to the exemplary embodiments of the invention, examples of which are illustrated in the accompanying drawings. Wherever possible, the same reference numbers will be used throughout the drawings to refer to the same or like parts (elements).

A system and method can use statistical modeling of the way that an entire application environment is running. The output from the statistical models can be used by an optimization engine to provide an optimal or near optimal configuration and operation of the application environment for nearly any workloads and conditions. After constructing the statistical models, the operation can be entirely automated and not require human intervention. In another embodiment, some human intervention may be used or desired, particularly for non-reoccurring events (e.g., significant portion of a network for the application environment shut down due to a natural disaster). The system and method can be used to respond faster (closer to real time) and potentially implement better control than would otherwise be possible with manual control. The system and method is particularly well suited for application environments that are in a nearly constant state of flux.

A few terms are defined or clarified to aid in understanding the descriptions that follow. The term “application environment” is intended to mean any and all hardware, software, and firmware used by an application. The hardware can include servers and other computers, data storage and other memories, switches and routers, and the like. The software used may include operating systems.

The term “element-state” is intended to mean a state of an element within the network. Elements are hardware or software components, such as servers, memories, processors, controllers, and the like. Element-state variables can include CPU frequency, memory access times, and the like.

The term “exogenous” is intended to mean “outside a data center.” Exogenous variables can include workload, time of day, and the like.

The term “instruments” is intended to mean controls and corresponding control settings, gauges, and buttons. Examples can include response time, throughput, and the like.

As used herein, the terms “comprises,” “comprising,” “includes,” “including,” “has,” “having” and any variations thereof, are intended to cover a non-exclusive inclusion. For example, a method, process, article, or apparatus that comprises a list of elements is not necessarily limited to only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods, hardware, software, and firmware similar or equivalent to those described herein can be used in the practice or testing of the present invention, suitable methods, hardware, software, and firmware are described below. All publications, patent applications, patents, and other references mentioned herein are incorporated by reference in their entirety. In case of conflict, the present specification, including definitions, will control. In addition, the methods, hardware, software, and firmware and examples are illustrative only and not intended to be limiting.

Unless stated otherwise, components may be bi-directionally or uni-directionally coupled to each other. Coupling should be construed to include direct electrical connections and any one or more of intervening switches, resistors, capacitors, inductors, and the like between any two or more components.

To the extent not described herein, many details regarding specific hardware, software, firmware components and acts are conventional and may be found in textbooks and other sources within the computer, information technology and networking arts.

Before discussing embodiments of the present invention, an exemplary hardware architecture for using embodiments of the present invention is described.

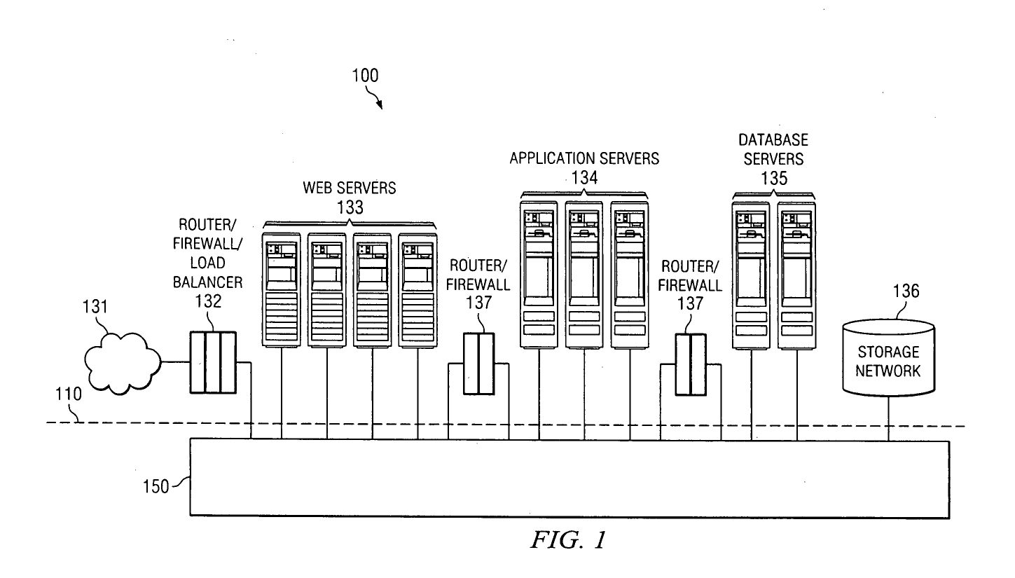

FIG. 1 includes a hardware diagram of a system 100. The system 100 includes a network 110, which is the portion above the dashed line in FIG. 1. The network 110 includes the Internet 131 or other network connection, which is coupled to a router/firewall/load balancer 132. The network 110 further includes Web servers 133, application servers 134, and database servers 135. Other computers may be part of the network 110 but are not illustrated in FIG. 1. The network 110 also includes storage network 136 and router/firewalls 137. Although not shown, other additional components may be used in place of or in addition to those components previously described. Each of the components 132-137 are bi-directionally coupled in parallel to an appliance (apparatus) 150. In the case of router/firewalls 137, the inputs and outputs from such router/firewalls 137 are connected to apparatuses 150. Substantially all the traffic for components 132-137 in network 110 is routed through the appliance 150. Software agents may or may not be present on each of components 132-137. The software agents can allow the appliance 150 to monitor and control at least a part of any one or more of components 132-137. Note that in other embodiments, software agents may not be required in order for the appliance 150 to monitor and control the components.

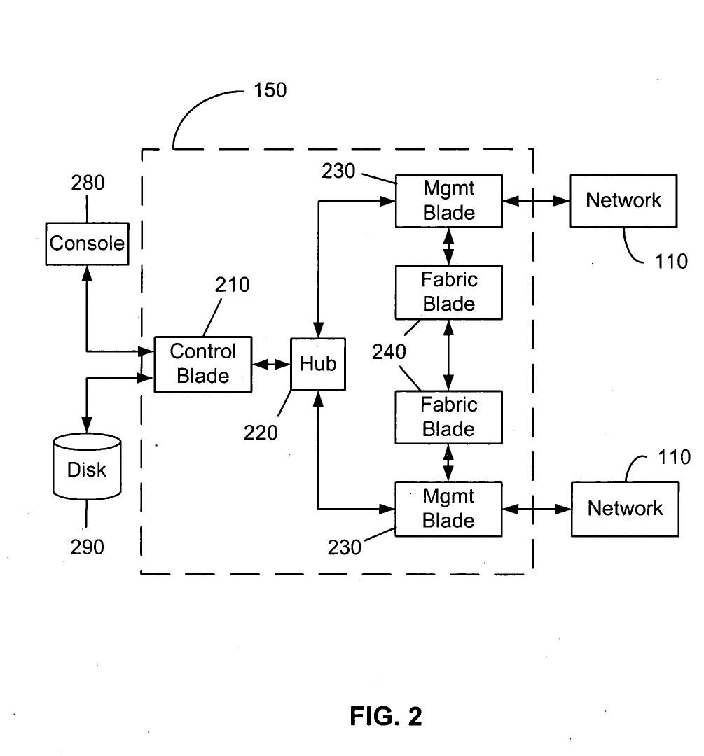

FIG. 2 includes a hardware depiction of the appliance 150 and how it is connected to other components of the system. A console 280 and a disk 290 are bi-directionally coupled to a control blade 210 within the appliance 150. The console 280 can allow an operator to communicate with the appliance 150. Disk 290 may include data (e.g., state information 420) collected from or used by the control blade 210. The control blade 210 is bi-directionally coupled to a hub 220. The hub 220 is bi-directionally coupled to each management blade 230 within the appliance 150. Each management blade 230 is bi-directionally coupled to the network 110 and fabric blades 240. Two or more of the fabric blades 240 may be bi-directionally coupled to one another.

Although not shown, other connections and additional memory may be coupled to any or all of the components within the appliance 150. Further, nearly any number of management blades 230 may be present. For example, the appliance 150 may include one or four management blades 230. When two or more management blades 230 are present, they may be connected to different parts of the network 110. Similarly, any number of fabric blades 240 may be present and under the control of the management blades 230. In still another embodiment, the control blade 210 and hub 220 may be located outside the appliance 150, and nearly any number of apparatuses 150 may be bi-directionally coupled to the hub 220 and under the control of control blade 210.

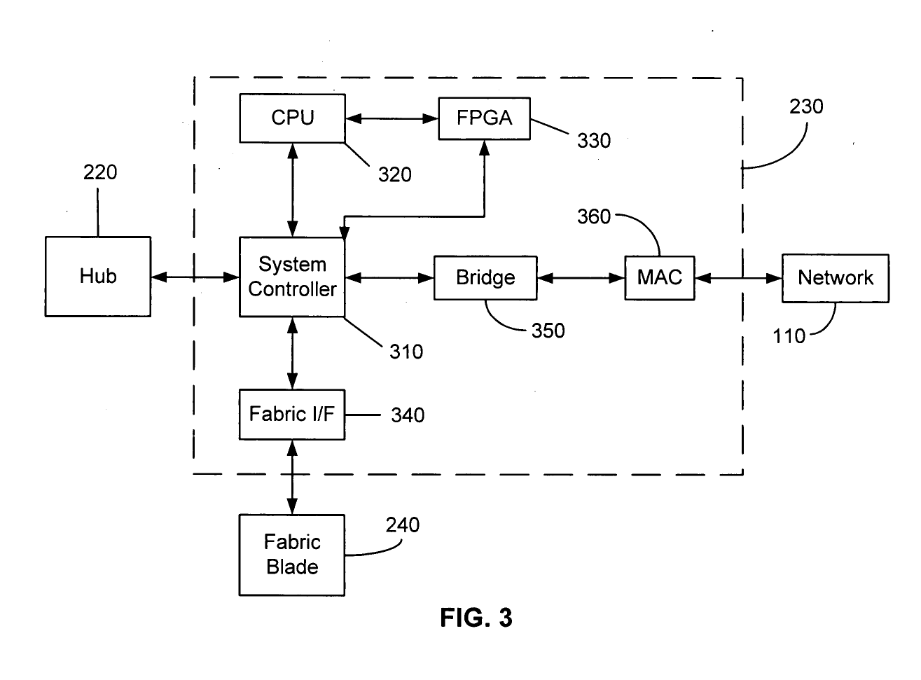

FIG. 3 includes an illustration of one of the management blades 230, which includes a system controller 310 bi-directionally connected to the hub 220, central processing unit (“CPU”) 320, field programmable gate array (“FPGA”) 330, bridge 350, and fabric interface (“I/F”) 340, which in one embodiment includes a bridge. The CPU 320 and FPGA 330 are bi-directionally coupled to each other. The bridge 350 is bi-directionally coupled to a media access control (“MAC”) 360, which is bi-directionally coupled to the network 110. The fabric I/F 340 is bi-directionally coupled to the fabric blade 240.

More than one of some or all components may be present within the management blade 230. For example, a plurality of bridges substantially identical to bridge 350 may be used and bi-directionally coupled to the system controller 310, and a plurality of MACs substantially identical to MAC 360 may be used and bi-directionally coupled to the bridge(s) 350. Again, other connections and memories (not shown) may be coupled to any of the components within the management blade 230. For example, content addressable memory, static random access memory, cache, first-in-first-out (“FIFO”) or other memories or any combination thereof may be bi-directionally coupled to FPGA 330.

The appliance 150 is an example of a data processing system. Memories within the appliance 150 or accessible by the appliance 150 can include media that can be read by system controller 310, CPU 320, or both. Therefore, each of those types of memories includes a data processing system readable medium.

Portions of the methods described herein may be implemented in suitable software code that may reside within or accessibly to the appliance 150. The instructions in an embodiment of the present invention may be contained on a data storage device, such as a hard disk, a DASD array, magnetic tape, floppy diskette, optical storage device, or other appropriate data processing system readable medium or storage device.

In an illustrative embodiment of the invention, the computer-executable instructions may be lines of assembly code or compiled C⁺⁺, Java, or other language code. Other architectures may be used. For example, the functions of the appliance 150 may be performed at least in part by another apparatus substantially identical to appliance 150 or by a computer, such as any one or more illustrated in FIG. 1. Additionally, a computer program or its software components with such code may be embodied in more than one data processing system readable medium in more than one computer.

Communications between any of the components 132-137 and appliance 150 in FIG. 1 can be accomplished using electronic, optical, radio-frequency, or other signals. When an operator is at the console 280, the console 280 may convert the signals to a human understandable form when sending a communication to the operator and may convert input from a human to appropriate electronic, optical, radio-frequency, or other signals to be used by and one or more of the components 132-137 and appliance 150.

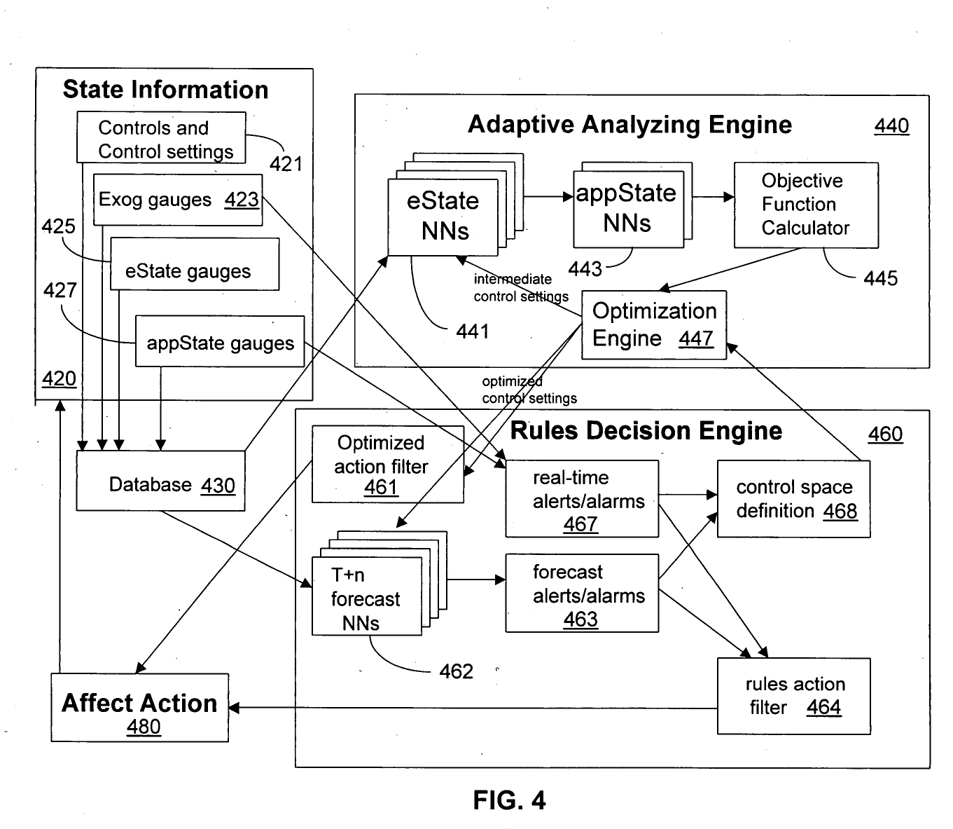

Attention is now directed to a software architecture in accordance with one embodiment of the present invention. The software architecture and method of operation during normal operation (not during learning, which is described later) is illustrated in FIGS. 4-6, respectively.

A high level description of an embodiment is given before addressing the details of the system and method. In FIG. 4, the equipment (not shown in FIG. 4) for collecting the state information 420 may be coupled to a database 430 and a rules decision engine (“RDE”) 460. The database 430 may be coupled to an adaptive analyzing engine (“AAE”) 440 and the RDE 460. The RDE 460 may be coupled to controls, wherein the output from the RDE 460 can affect action(s) 480 by adjusting, directly or indirectly, control(s) for the network.

Briefly referring to FIGS. 1-3, data may originate from components 132-137 within the network 110, and the appliance 150 may collect and store state information 420 within the database 430 (not shown in FIG. 1). The AAE 440 and RDE 460 may be located within the control blade 210, management blade(s) 230, or both of the appliance 150. Within the management blade 230, at least part of the AAE 440, RDE 460, or both may include at least part(s) of CPU 320. After reading this specification, skilled artisans appreciate that this exemplary embodiment does not limit the scope of the present invention and many other embodiments are possible.

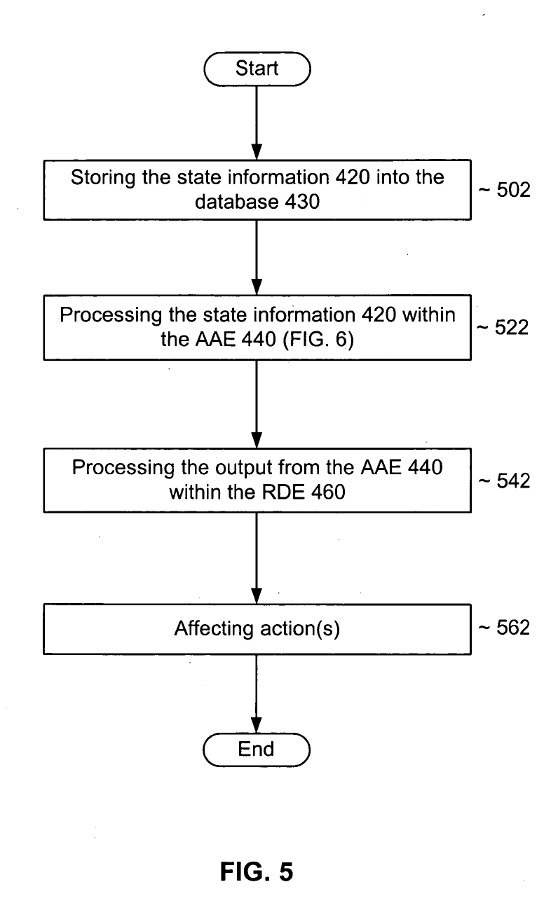

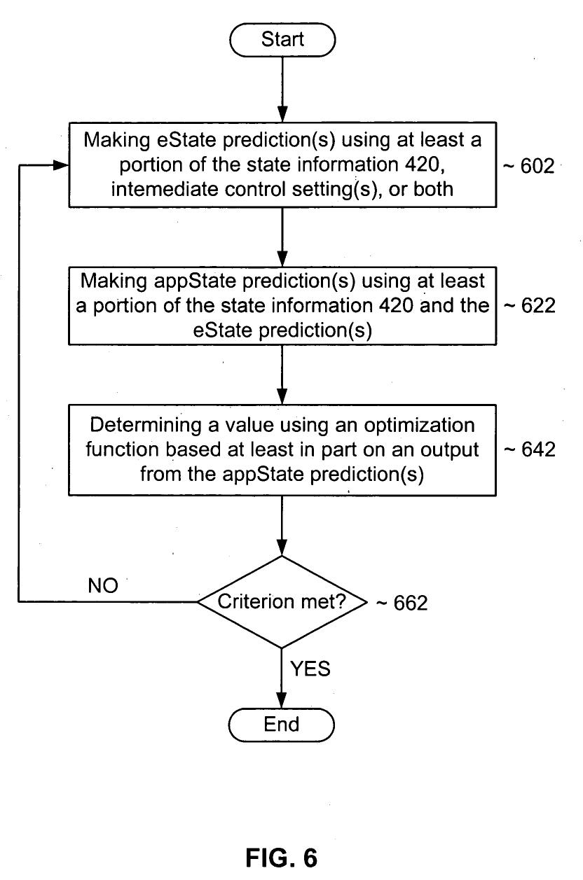

FIG. 5 includes a non-limiting, exemplary method of using the architecture in FIG. 4. The method can include storing the state information 420 into the database 430 (block 502 in FIG. 5), processing the state information 420 within the AAE 440 (block 522), processing the output from the AAE 440 within the RDE 460 (block 542), and affecting action(s) (block 562). The operation of processing the state information 420 within the AAE 440 (block 522) is addressed in more detail in FIG. 6.

Attention is now directed to the details of an embodiment of the architecture for a system and method of managing an application environment. In FIG. 4, state information 420 is collected and includes controls and control setting 421, exogenous (“exog”) gauges 423, element-state (“eState”) gauges 425 and application-state (“appState”) gauges 427.

The controls and control settings 421 can represent a type of control and its current setting, respectively. For example, a control may include the number of servers currently provisioned (in use or substantially immediately available for use (i.e., idling)) in the network, and the control setting may be 4, assuming 4 servers are currently set as being provisioned.

The exogenous gauges 423 include attributes originating from outside a data center. The exogenous gauges 423 may measure or monitor workload (e.g., type and number of requests for the network to perform work from applications using at least part of the network), time of day, and the like.

The estate gauges 425 measure or monitor the state of hardware elements, software elements, or both within the network. The estate gauges 425 can include CPU frequency, memory access times, and the like. Element-state variables can include CPU frequency (e.g., instructions per second), memory access times, and the like.

The appstate gauges 427 measure or monitor the state of the application within the network. The appstate gauges 427 may be dedicated to getting more precise readings on certain types of variables. For example, if response time is the key parameter to which the application environment is to be optimized, the appstate gauges 427 may measure or monitor response time, workload, throughput, and request failures. The data may be broken down by the type of workload or transaction (i.e., request for action on the part of the network). In one embodiment, each transaction may be classified by type (request for a specific web page, purchasing a product or service, inventory management, etc.), response time for each transaction within that time, and the number of times that type of transaction was requested. Because information for appstate gauges 427 is usually more important than the estate gauges 425, more precision in readings from appState gauges 427 (compare to estate gauges 425) may be used. If a different parameter is being optimized (e.g., CPU utilization), different appState gauges 427 may be used. After reading this specification, skilled artisans can modify the number and types of variables to be measured or monitored by the appState gauges 427.

After the state information 420 is collected, the method can include storing the state information 420 into the database 430 (block 502 in FIG. 5). In other embodiments, the state information 420 may be stored in another persistent storage form or format (e.g., storing data as in file(s) on one or more hard disks, etc.). After reading this specification, skilled artisans will appreciate that the form and format for storing data can be tailored to meet their needs or desires.

The method can continue with processing the state information 420 within the AAE 440 (block 522 in FIG. 5). FIG. 6 includes a process flow for one non-limiting exemplary embodiment for carrying out the operation. A statistical predictive modeling method can be used to make predictions for estate and appState variables. In the embodiment described herein, neural networks are used. However, another statistical predictive models including regression or the like may be used.

In one embodiment, the method can include making estate prediction(s) using at least a portion of the state information 420, the intermediate control setting(s), or both (block 602 in FIG. 6). During the first pass through the AAE 440, state information 420 from database 430 is used. The state information 420 may be obtained by AAE 440 from database 430. The estate neural network (“NN”) 441 may initially take the state information 420 (original data) and predict the state(s) of the component(s) within the network.

The method can also include making appstate prediction(s) using at least a portion of the state information 420 and the estate prediction(s) (block 622). The state information 420 and estate prediction(s) can be processed by the appstate NN 443 to provide predictions of the state of the application.

The method can further include determining a value using an optimization function based at least in part on an output from the appstate prediction(s). The state information 420, estate prediction(s), and appState prediction(s) can be processed by the objective function calculator 445 to provide a value. The technique used by the objective function calculator 445 may calculate a cost, revenue, profit, response time, throughput, or nearly any other variable.

The output from the objective function calculator 445 is sent to the optimization engine 447. The optimization engine 447 can include commercially available optimization software. The optimization engine 447 can compare the output from the calculator and determine if it meets a criterion. If the criterion is met, the optimization engine 447 may pass information regarding any one or more of the predicted state information (predicted control(s), control setting(s) and gauge reading(s)) to the RDE 460.

In some instances, the criterion is not met using the first set of predictions. Depending on the variable, the value of the variable from the calculator 445 may need to be closer to a minimized, a maximized, or an optimized value. The optimization engine 447 may take the predicted state information (including predictions from estate NN 441 and appState 443) and control space definitions 468 from RDE 460 to determine intermediate control settings. The control space definitions 468 may define the allowed range of controls and frequency at which they may be changed. The control space definitions 468 are addressed in more detail below. The intermediate control settings should fall within the control space definitions 468.

The intermediate control settings may be sent to eState NN 441 to make further eState prediction(s). The intermediate control settings and estate prediction(s) may be sent to appState NN 443 to make further appstate prediction(s). The intermediate control settings, estate prediction(s), appstate prediction(s) may be sent to the objective function calculator 445 to make another calculation. If the criterion is met, the optimized control settings are sent to the RDE 460. Otherwise, the loop including estate NN 441, appstate NN 443, objective function calculator 445 and optimization engine 447 is iterated until the criterion is met. Although the optimization engine 447 may be trying to minimize or maximize a value from the objective function calculator 445, the actual minimum or maximum may or may not be achieved. The criterion may be used to help keep the AAE 440 from continuing in an infinite loop. In one embodiment, a response time of 0 may never be achieved. However, if the response time is at 1 ms or lower, the criterion may be deemed to be met, and iterative looping may be terminated at that time.

In summary, the AAE 440 uses the state information 430 from database 430 during the first pass through the estate NN 441, appstate 443, objective function calculation 445, and optimization engine 447. After the initial pass, the loop defined by estate NN 441, appstate 443, objective function calculator 445, and optimization engine 447 can be iterated using intermediate control settings until the output from the objective function calculator 445 meets a criterion.

The method can further include affecting action(s) (block 562 in FIG. 5). RDE 460 may affect action 480 by sending communications to the affected component(s) regarding the control settings. Software agent(s) on the managed component(s) may receive one or more of the control settings and forward a communication to a controller for the managed component regarding the control setting(s) for that component. In one embodiment, one component in the network does not have its setting(s) changed (already at the control setting(s)), and another component in the network may have its setting(s) changed to match the setting(s) sent to the software agent. For example, first, second, and third server computers may be provisioned (in use or ready for use), and a fourth server computer may be de-provisioned (not in use or not ready for use). The fourth server computer may be provisioned by sending a request to a software agent on the fourth server computer. The same request may or may not be sent to the other server computers (first, second, and third). If sent to the other server computers, the request may be effectively ignored by those other server computers because the request was intended to change the state of the fourth server computer, not the other three server computers. After reading this specification, skilled artisans will appreciate that a component may already be configured to allow for at least some external control and may not require a separate software agent.

Before affecting action(s), the optimized control settings and potentially predicted state information (from the estate NN 441 and the appstate NN 443) from the AAE 440 may be processed within the RDE 460. The RDE 460 can allow a user of the system to define nearly any type and number of rules to override or modify the optimized control settings from the AAE 440 before action is taken. For example, historical data may indicate that the optimized control settings for a particular condition are incorrect or not truly optimal. The RDE 460 may override the optimized control settings and use other control settings that are believed to provide a better solution. As networks become more complex, users are cautioned not to arbitrarily ignore optimized control settings because the system is capable of providing counterintuitive solutions that can end up being better than anything humans would have achieved.

In one embodiment, the optimized control settings may be sent to an optimized action filter 461. If desired, the optimized control settings may be processed by the optimized action filter 461 to determine if any or all the optimized control settings should be used without any further action. If the optimized control settings pass the optimized action filter 461, the RDE 460 can affect action 480 as previously described.

In another embodiment, the optimized control settings may be sent to a T+n forecast NN 462. The T+n forecast NN 462 may also receive data from the database 430. The T+n forecast NN 462 can take the optimized control settings from the AAE 440 and data from the database 430 to determine how the network will respond in the future. The output from the T+n forecast NN 462 can be sent to forecast alerts/alarms module 463. The forecast alerts/alarms module 463 can determine whether an alert or alarm condition would occur given the output from the T+n forecast NN 462. The output from the forecast alerts/alarms module 463 may be sent to the control space definition 468, the rules action filter 464, or both. The control space definition 468 may automatically update the control space for the control (range of settings, change frequency, or both) if the control settings are predicted to cause a significantly adverse condition. If the control settings are predicted to cause an insignificantly adverse condition (e.g., a warning), the control space definition 468 may not be automatically changed. In still another embodiment, manual intervention may be used to update the control space definition 468 based on the forecast alerts/alarms module 463. The data from the T+n forecast NN 462 and forecast alerts/alarms 463 may be passed to rules action filter 464.

The rules action filter 464 can allow the optimized control settings take effect, prevent the optimized control settings from taking effect, or modify any one or more of the optimized control settings before affecting action 480. The user may be aware of a unique situation that may not have occurred during a learning session for any one or more of the neural networks or otherwise is not correctly predicted by the statistical predictive model(s) (e.g., collinearities if linear or multiple linear regression is used). Other situations may occur where the rules actions filter 464 may prevent or modify control settings before action is affected. The output from the rules action filter 464 may affect action 480 similar to optimized action filter 461.

The RDE 460 may also be configured to address real-time alerts and alarms using real-time alerts/alarms module 467. Any or all of state information 420 may be sent to the real-time alerts/alarms module 467. For example, data from the exogenous gauges 423, appState gauges 427, or other state information 420, or any combination thereof may be sent to the real-time alerts/alarms module 467. The processing of data and other actions are substantially identical to those that occur with the forecast alerts/alarms 463 except that the rules may define actions to take when a real-time alert/alarm 467 occurs, whereas, a forecast alert/alarm 463 may cause the rules action filter 464 to not affect or modify optimized control setting(s).

As previously described, neural networks may be used as part of the predictive modeling for the system and method. In one embodiment, the neural networks include mathematical encapsulations of the relationships between the controls and the gauges. Before using a neural network, it can be put into a learning mode. Limits on the controls are typically set as part of the control space definition 468 before learning begins. For example, a control may allow a setting from 0-20, but a user may define a narrower range, such as 6-15, to be used. During learning, the control will not be allowed to exceed its pre-defined setting range limits (e.g., 6-15), to the extent there are defined limits.

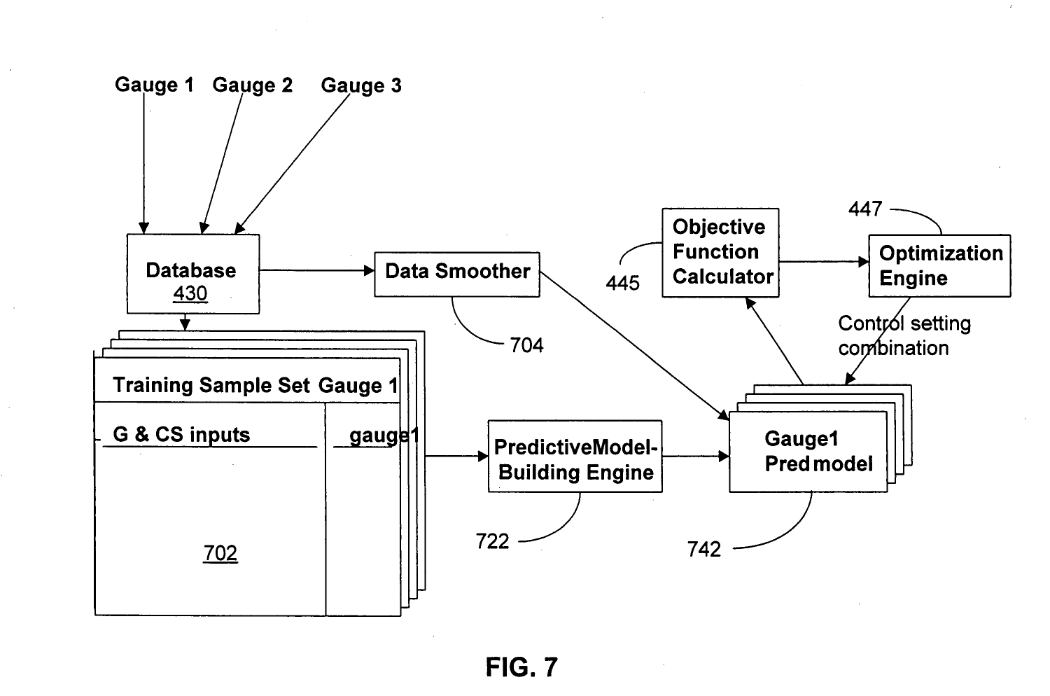

FIG. 7 includes an illustration regarding a method of performing a learning session. During the learning session, any or all of the controls may be exercised over their entire defined range of settings. The learning session is performed to determine which combinations of controls and settings work well and which combinations of controls and settings work poorly.

As the controls are exercised during the learning session, data from gauges (e.g., Gauge 1, Gauge 2, Gauge 3, etc.) are collected and stored in the database 430. The gauges may include any or all of the exogenous gauges 423, estate gauges 425, and appState gauges 427 as previously described. The data from database 430 can be used to create a set of training samples 702 for each of the gauges. Basically, for each combination of control settings, Gauge 1 readings are recorded. The set of training samples 702 for Gauge 1 are sent to a predictive model building engine 722. The engine 722 can include commercially available neural network building software.

Data from the database 430 may also be processed by a data smoother 704. In many networks, data cannot reasonably be gathered in a synchronous manner over all components. Different components may take readings at different points in time and at different rates. Therefore, the data is asynchronous. The data smoother 704 tries to create pseudo-synchronous data from asynchronous data. The reading from a gauge at a point or period in time may not be taken during that point or period in time but may be averaged using readings before, after, or before and after that point or period in time. Alternatively, when a data from a time period is being examined, a plurality of readings may be taken. An averaged value from the period may be determined from the plurality of readings. If all the data for the gauges can be transformed to pseudo-synchronous data, it can be used.

The data smoother 704 can also examine readings from one or more gauges and can determine if the time between the last reading(s) and the point in time are too long as to not be trustworthy. Rules can be defined when too much time has passed since the last reading. If too much time has passed when the reading on one or more gauges was taken, the data is rejected and may not be part of the data used with the predictive model. Data collected during abnormal conditions (power outage, etc.) may also be rejected. In this manner, the predictive model is built using relatively clean data.

The output from the data smoother 704 and predictive model building engine 722 can be used to build a set of predictive models 742. In this manner, the predictive models can be built using data that all have the same relative time line. The set may include predictive models for each of the gauges. The predictive models for the elements form the estate NN 441, and the predictive models for the applications form the appstate NN 443.

After the learning mode is complete, the predictive models can be used to help optimize the application environment being used with the objective function calculator 445 and optimization engine 447.

The learning session can be repeated for any number of reasons. Components (particularly hardware) can degrade over time. Also, components may be added, removed or replaced. Simply put, the application environment may have significantly changed. The historical data may be obsolete. Further, actual and predicted gauge readings may be compared during normal operation as illustrated in FIG. 4. In one example, a prior learning session may have been performed on sparse (not enough) data or accuracy of the model is unacceptable. If the application environment significantly changes or predicted models are not working well (too large of a gap between predicted and actual gauge readings), another learning session may be performed. After reading this specification, skilled artisans will know when to implement training sessions for the neural networks.

In another embodiment, an ontology may be used to provide a starting point for AAE 440. The previous embodiments work well for helping to optimize the application environment. For abnormal conditions, the ontology may be used to help provide starting points for the controls and control settings instead of using the current controls and control settings. In one example, the network may work well with a server farm having five server computers. Normal operations may be that 2-5 server comptuers are provisioned at any point in time. When no server computers or one server computer is provisioned, the application environment may be deemed abnormal, unstable, or the like. An ontology enginecan be used in matching state information 420 with a known state. The operation of the ontology is described in more detail below.

Similar to the neural networks, a learning session may be used to build the ontology. In one embodiment, fault insertions in hardware, software, or both may be used. For example, the server farm may be disconnected or shut down. The state information 420 would be gathered to create an identifying signature for when the server farm disconnection or shut down. Eventually, the server farm or individual servers may be reconnected or rebooted. The ontology may have initial control and control settings more specifically tailored to recovering from a specific abnormal situation.

The process may be repeated for a memory event (e.g., inventory database disconnected or otherwise unavailable, etc.) The process can be repeated for other likely or potential fault conditions. Database 430 may include a separate ontology table having values (or range(s) of values) for state information corresponding to a known fault condition.

When the ontology is used, the current state information 420 may be processed by an ontology engine (not shown) that may be coupled to at least two of the state information 420, the database 430, and the estate NN 441. The ontology engine can use logic to compare current state information with signatures of known abnormal conditions. Note that the comparison may not need to have all of the current state information to make an match. For example, state information for memory may not be required to determine the server farm is disconnected or shut down. If a match is made (at least a portion of the current state information 430 matches an identifying signature (e.g., values within an entry in an ontology table)), the ontology engine may retrieve controls and control settings from that ontology table within database 430. The ontology engine may provide initial controls and control settings that are different from the current controls and control settings 443. The ontology engine can send those initial controls and control settings (which would be original controls and control settings in this embodiment) to the AAE 440 (e.g., the estate NN 441). Otherwise (no match), the ontology engine allows the operation of the system and method to proceed as previously described (as if the ontology engine were not present).Some care may be exercised regarding the ontology engine. The method and system work very well during normal operation. Having too many abnormal conditions defined may slow down the operation due to comparisons (determining if current state information 420 matches an identifying signature for a known abnormal condition) or cause an otherwise normal condition to be detected as an abnormal condition, potentially because there are too many pre-defined abnormal conditions. After reading this specification, skilled artisans will be able to tailor better the system to their needs.

Embodiments described herein can help to produce an automated, sustainable application environment optimizing system. In one embodiment, the system and method can examine the application environment from a higher level of abstraction than typically used in the prior art for optimizing operations on a network that work only with estate components and predictions. The system and method can use estate and appstate predictions to optimize better the application environment. To the inventors' knowledge, appstate predictions have not been used. The appstate prediction provides additional relevant information that helps to improve optimization. This ability allows for a more robust method and system to be achieved.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

1. A method of managing an application environment on a network comprising:
using predictive modeling based at least in part on state information originating from the network to generate an output;
determining a value using an optimization function based at least in part on the output from the predictive modeling; and
determining if a criterion is met based at least in part on the value.

2. The method of claim 1, further comprising automatically changing a control from an original control setting to a new control setting after using the predictive modeling.

3. The method of claim 2, further comprising applying a filter to the new control setting after determining if the criterion is met.

4. The method of claim 2, further comprising forecasting a behavior of the application environment using the new control setting.

5. The method of claim 1, wherein using predictive modeling comprises:
making an estate prediction using at least a portion of the state information; and
making an appState prediction using at least a portion of the state information and the estate prediction.

6. The method of claim 5, wherein the estate prediction is a function of an exogenous variable and an original control setting.

7. The method of claim 6, wherein the appstate prediction is a function of the exogenous variable and the estate prediction.

8. The method of claim 1, further comprising iterating (1) using predictive modeling to generate at least one additional output and (2) determining at least one additional value using the optimization function based at least in part the at least one additional output, wherein iterating continues, until one or more of the at least one additional value meets a criterion.

9. An apparatus for carrying out the method of claim 1.

10. A method of managing an application environment on a network comprising:
determining whether state information matches an entry within an ontology, wherein the state information comprises an original control setting for a control;
changing the control from the original control setting to a new control setting after determining whether the state information matches the entry within the ontology.

11. The method of claim 10, further comprising:
using predictive modeling based at least in part on the original control setting; and
determining a value using an optimization function based at least in part on an output from the predictive modeling.

12. The method of claim 11, further comprising determining if a criterion is met based at least in part on the value.

13. The method of claim 11, wherein using predictive modeling comprises:
making an estate prediction using at least a portion of the state information; and
making an appState prediction using at least a portion of the state information and the estate prediction.

14. The method of claim 11, further comprising iterating (1) using predictive modeling to generate at least one additional output and (2) determining at least one additional value using the optimization function based at least in part the at least one additional output, wherein iterating continues until one or more of the at least one additional value meets a criterion.

15. An apparatus operable to carryout the method of claim 10.

16. A data processing system readable medium having code for managing an application environment on a network, wherein the code is embodied within the data processing system readable medium, the code comprising:
an instruction for using predictive modeling based at least in part on state information originating from the network to generate an output;
an instruction for determining a value using an optimization function based at least in part on the output from the predictive modeling; and
an instruction for determining if a criterion is met based at least in part on the value.

17. The data processing system readable medium of claim 16, wherein the code further comprises an instruction for automatically changing a control from an original control setting to a new control setting after the instruction for using the predictive modeling.

18. The data processing system readable medium of claim 17, wherein the code further comprises an instruction for applying a filter to the new control setting, wherein the instruction for applying the filter is executed after the instruction for determining if the criterion is met.

19. The data processing system readable medium of claim 17, wherein the code further comprises an instruction for forecasting a behavior of the application environment using the new control setting.

20. The data processing system readable medium of claim 16, wherein the instruction for using predictive modeling comprises:
an instruction for making an estate prediction using at least a portion of the state information; and
an instruction for making an appstate prediction using at least a portion of the state information and the estate prediction.

21. The data processing system readable medium of claim 20, wherein the estate prediction is a function of an exogenous variable and an original control setting.

22. The data processing system readable medium of claim 21, wherein the appState prediction is a function of the exogenous variable and the estate prediction.

23. The data processing system readable medium of claim 16, wherein the code further comprises an instruction for iterating (1) the instruction for using predictive modeling to generate at least one additional output and (2) the instruction for determining at least one additional value using the optimization function based at least in part the at least one additional output, wherein the instruction for iterating continues until one or more of the at least one additional value meets a criterion.

24. A data processing system readable medium having code for managing an application environment on a network, wherein the code is embodied within the data processing system readable medium, the code comprising:
an instruction for determining whether state information matches an entry within an ontology, wherein the state information comprises a current control setting for a control;
an instruction for changing information for the control from the current control setting to an original control setting after executing the instruction for determining whether the state information matches the entry within the ontology.

25. The data processing system readable medium of claim 24, wherein the code further comprises:
an instruction for using predictive modeling based at least in part on the original control setting; and
an instruction for determining a value using an optimization function based at least in part on an output from the predictive modeling.

26. The data processing system readable medium of claim 25, wherein the code further comprises an instruction for determining if a criterion is met based at least in part on the value.

27. The data processing system readable medium of claim 25, wherein the instruction for using predictive modeling comprises:
an instruction for making an estate prediction using at least a portion of the state information; and
an instruction for making an appState prediction using at least a portion of the state information and the estate prediction.

28. The data processing system readable medium of claim 25, wherein the code further comprises an instruction for iterating (1) the instruction for using predictive modeling to generate at least one additional output and (2) the instruction for determining at least one additional value using the optimization function based at least in part the at least one additional output, wherein the instruction for iterating continues until one or more of the at least one additional value meets a criterion.

29. A system for managing an application environment on the network comprising an optimization engine that is configured to use state information originating from the network.

30. The system of claim 29, further comprising a rules decision engine.

31. The system of claim 30, wherein the rules decision engine comprises a neural network for forecasting state information based in least in part on control settings.

32. The system of claim 29, further comprising a first neural network for making an estate prediction coupled to the optimization engine.

33. The system of claim 32, further comprising a second neural network for making an appState prediction, wherein the second neural network is coupled to the first neural network and the optimization engine.
